(19) United States
(12) Patent Application Publication
(10) Pub. No.: US 2005/0166053 A1
(43) Pub. Date: Jul. 28, 2005

(54) Method and system for associating a signature with a mobile device

(75) Inventors: Yingqing Lawrence Cui, San Jose, CA (US); Zhaowei Jiang, San Jose, CA (US); Min Zhou, Palo Alto, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 10/767,004

(22) Filed: Jan. 28, 2004

(51) Int. Cl. H04L 9/00

(52) U.S. Cl. 713/176

(57) ABSTRACT

A method, apparatus, and system are directed towards associating a device signature with a mobile device. The invention is configured to determine at least one level of trust associated with the mobile device and an associated carrier gateway. In one embodiment, the mobile device may have multiple levels of trust associated with it. One tier of trust may be determined based on whether the mobile device provides a device identifier. Another tier of trust may be determined based on whether the mobile device is configured to receive a cookie. Still a third tier of trust may be determined based on a dynamic session identifier. The level of trust may also be determined based, in part, on a trust associated with the carrier gateway.

### FIELD OF THE INVENTION

The present invention relates generally to computing security, and more particularly to determining a device signature associated with a mobile device.

### BACKGROUND OF THE INVENTION

In today's society, mobile computing devices are becoming increasingly more common. Many mobile computing devices, such as laptops, personal digital assistants, cellular phones, and the like, may be employed to obtain information from another computing device, such as a desktop computer, a server, and the like. For example, a user of the mobile computing device may seek to access a web page, a directory, and the like, from the other computing device.

Often during such communications, the other computing device may request identification of the mobile computing device. The identification may be required to ensure that the mobile computing device is permitted to access the information. The identification may also enable the other computing device to perform certain actions, and the like, for the mobile computing device.

Some mobile computing devices today provide a mechanism for identifying themselves, such as a Mobile Identification Number (MIN), and the like. However, other mobile computing devices in use today do not provide a mechanism for identifying themselves. Still other mobile computing devices may be configured to not provide identification. In some instances, a lack of a device identifier may result in unnecessary denial of certain services, an inability of a server to perform certain actions, and the like. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention; and

FIG. 3 illustrates a logical flow diagram generally showing one embodiment for determining a device signature for a mobile device, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

Briefly stated, the present invention is directed towards providing a system, apparatus, and method for determining a signature associated with a mobile computing device. The mobile computing device is configured to provide to a server information associated with a user agent that may be executing on it. The mobile computing device may also provide an identifier, such as a Mobile Identification Number (MIN) number, and the like. A carrier may further provide information associated with a carrier gateway to the server. This information may include gateway group information, subscription identifier, and the like. The subscription identifier may include information associated with the MIN number, and the like, from the mobile computing device. In one embodiment, the gateway group information is obtainable from a header of a network packet associated with a carrier.

The server determines a level of trust to associate with the mobile computing device, based, in part, on the gateway group information, information associated with the user agent, the subscription identifier if it is provided, type of resource requested by the mobile computing device, and the like. The trust level result in a tier 1, 2, or 3 device signature being generated for the mobile computing device. The tier 1 device signature may include a hash of the subscription identifier, gateway group information, user agent information, and a time stamp. The tier 2 device signature may include a hash of a cookie that is generated by the server, the gateway group information, user agent information, and a time stamp. The tier 3 device signature may include a hash of the gateway group information, user agent information, an identifier associated with the server, an identifier associated with a process being requested by the mobile computing device. The hash for the tier 3 device signature may further include a random number and a time stamp.

Illustrative Operating Environment

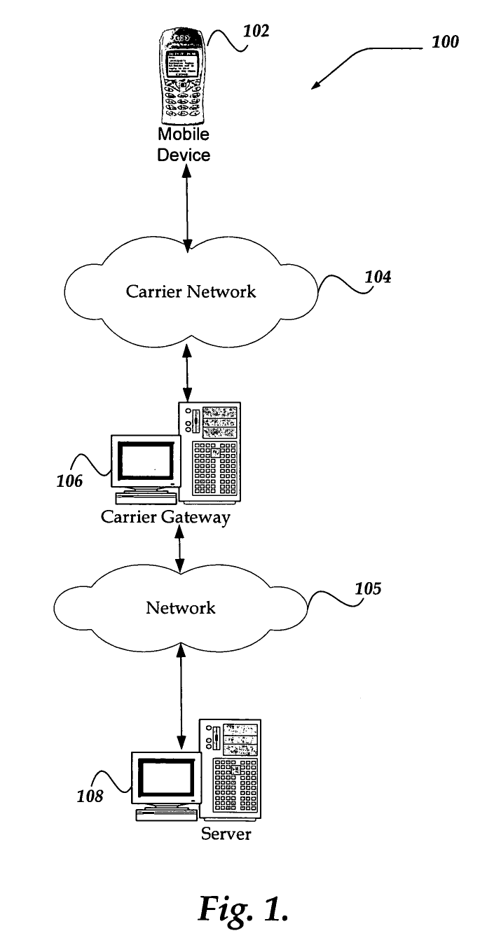

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes mobile device 102, carrier network 104, network 105, carrier gateway 106, and server 108. Network 104 is in communication with mobile device 102 and carrier gateway 106. Network 105 is in communication with carrier gateway 106 is in communication with server 108.

Generally, mobile device 102 may include virtually any portable computing device capable of connecting to another computing device and requesting information. Such devices include cellular telephones, smart phones, display pagers, radio frequency (RF) devices, infrared (IR) devices, integrated devices combining one or more of the preceding devices, and the like. Mobile device 102 may also include other devices, such as Personal Digital Assistants (PDAs), handheld computers, tablet computers, personal computers, multiprocessor systems, microprocessor-based or programmable consumer electronics, network PCs, wearable computers, and the like. As such, mobile devices typically range widely in terms of capabilities and features. For example, a cell phone may have a numeric keypad and a few lines of monochrome LCD display on which only text may be displayed. A web-enabled mobile device may have a touch sensitive screen, a stylus, and several lines of color LCD display in which both text and graphics may be displayed.

Mobile device 102 may include at least one user agent application that is configured to interpret and provide content to an end-user. Such user agents may include a capability to provide textual content, graphical content, voice content, and the like. In one embodiment, the user agent is a web browser that interprets web based content. The user agent may further provide information that identifies itself, including a type, capability, application name, application identifier, and the like. Such information may be provided in a message, or the like, sent to carrier gateway 106, server 108, and the like.

Mobile device 102 may have a keyboard, mouse, speakers, microphone, and an area on which to display information. Mobile device 102 may further include low-end devices that may have limited storage memory, reduced application sets, low bandwidth for transmission of a communication, and the like.

Mobile device 102 may provide a message, network packet, and the like, that includes a Mobile Identification Number (MIN). A MIN may include a North American Numbering Plan (NANP) number that is configured to serve as a mobile telephone number for mobile device 102. MINs may be programmed into mobile device 102 at time of manufacture, purchase, and the like. Mobile device 102 is not limited to providing a MIN number as an identifier, and another identifier may also be provided, such as an electronic serial number (ESN), application serial number, and the like, without departing from the scope of the invention. In one embodiment, mobile device 102 includes a device identification component configured to provide the MIN, ESN, application serial number, and the like.

In one embodiment, mobile device 102 is configured to provide a biometric, code, key, and the like, associated with the end-user of the mobile device.

Mobile device 102 also may be configured without a MIN, or other readily accessible device identifier. Mobile device 102 may also be configured to not provide the MIN or other device identifier during a communication with another device, such as server 108.

Mobile device 102 may be configured to receive a cookie, token, and the like from server 108. Mobile device 102 may be further configured to store the cookie, token, and the like and provide it to server 108.

Mobile device 102 may include a client that is configured to manage a communication with the at least one user agent application, network interface components, such as a transceiver, and the like. The client may further operate within a processor (not shown) within mobile device 102 to manage a communication with carrier network 104, server 108, and the like. As such, the client may be configured to enable the sending of information associated with the at least one user agent, mobile device 102, and the like, as well as to receive information, including but not limited to, at least one device signature, cookie, content for display and the like, a Uniform Resource Locator (URL), and the like.

Carrier network 104 is configured to couple mobile device 102 and its components with carrier gateway 106. Carrier network 104 may include any of a variety of wireless sub-networks that may further overlay stand-alone ad-hoc networks, and the like, to provide an infrastructure-oriented connection for mobile device 102. Such sub-networks may include mesh networks, Wireless LAN (WLAN) networks, cellular networks, and the like.

Carrier network 104 may further include an autonomous system of terminals, gateways, routers, and the like connected by wireless radio links, and the like. These connectors may be configured to move freely and randomly and organize themselves arbitrarily, such that the topology of carrier network 104 may change rapidly.

Carrier network 104 may further employ a plurality of access technologies including, but not limited to, 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile device 102 with various degrees of mobility. For example, carrier network 104 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, carrier network 104 may include virtually any wireless communication mechanism by which information may travel between mobile device 102 and carrier gateway 106.

Carrier gateway 106 may include any computing device capable of connecting with mobile device 102 to enable communications with another computing device, such as server 108, another mobile device (not shown), and the like. Such devices include personal computers desktop computers, multiprocessor systems, microprocessor-based or programmable consumer electronics, network PCs, servers, and the like.

Carrier gateway 106 typically includes a carrier level service provider's computing device, and related infrastructure. Carrier gateway 106 may be configured to receive a network packet, and the like, from mobile device 102. The network packet, and the like, may include information associated with mobile device 102, such as a MIN number, information associated with the user agent operating on mobile device 102, and the like. The network packet may further include information associated with the end-user of mobile device 102.

Carrier gateway 106 may be further configured to generate a subscription identifier based, in part, on the MIN number, and other information provided by mobile device 102 that may uniquely identifier mobile device 102.

Carrier gateway 106 may also be configured to provide information to server 108. Such information may include, but is not limited to, the subscription identifier associated with mobile device 102; a gateway group identifier or the like associated with carrier gateway 106; information associated with the user agent of mobile device 102; information associated with the end-user of mobile device 102; and the like.

Network 105 is configured to couple server 108 and its components with carrier gateway 106. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between carrier gateway 106 and server 108.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

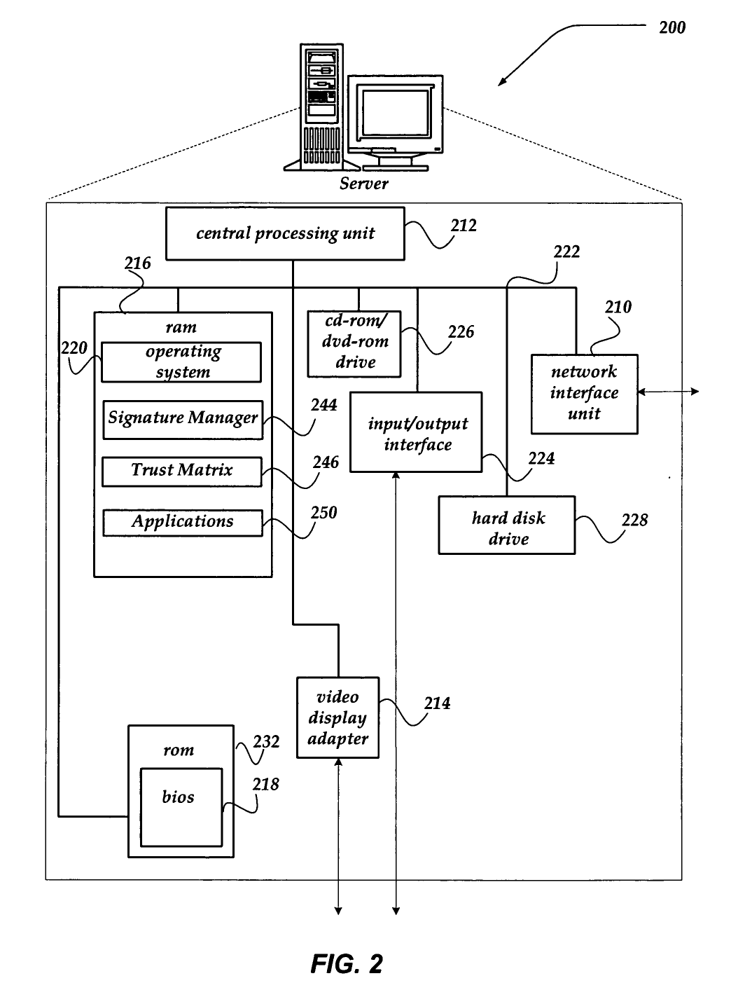

One embodiment of server 108 is described in more detail below in conjunction with FIG. 2. Briefly, however, Server 108 may include any computing device capable of connecting to mobile device 102, to provide information in response to a request from mobile device 102. Such devices include personal computers desktop computers, multiprocessor systems, microprocessor-based or programmable consumer electronics, network PCs, servers, and the like. Server 108 is further configured to determine at least one trust level associated with mobile device 102 and to generate at least one device signature based on the determined at least one trust level.

Illustrative Server Environment

FIG. 2 shows one embodiment of a server, according to one embodiment of the invention. Server 200 may include many more components than those shown. The components shown, however, are sufficient to disclose an illustrative embodiment for practicing the invention.

Server 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server 102. Any general-purpose operating system may be employed. Basic input/output system (“BIOS”) 218 is also provided for controlling the low-level operation of server 102. As illustrated in FIG. 2, server 200 also can communicate with the Internet, or some other communications network, such as network 105 in FIG. 1, via network interface unit 210, which is constructed for use with various communication protocols including the TCP/IP protocol. Network interface unit 210 is sometimes known as a transceiver or transceiving device.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, contact database programs, word processing programs, spreadsheet programs, and so forth. Mass storage may further include applications such as signature manager 244 and trust matrix 246.

Trust matrix 246 is configured to determine at least one level of trust associated with a mobile device. The trust level may be based in part on information associated with a carrier, such as associated with carrier gateway 106 of FIG. 1, and the like. For example, trust matrix 246 may determine that one carrier is more trustable than another carrier, based on a gateway group identifier, and the like. Trust matrix 246 may also determine a trust level based on the type of information a mobile device seeks to access, and the like. The trust level may be further determined based on whether the mobile device is enabled to provide a device identifier, accept a cookie, interact with a Uniform Resource Locator (URL), and the like.

Trust matrix 246 may be further configured to determine several trust levels associated with the mobile device. Trust matrix 246 may provide the determined trust level(s) to signature manager 244.

Signature manager 244 may receive information associated with a mobile device, a carrier's gateway, and the like, and determine at least one device signature for the mobile device. The at least one device signature may further be based on the at least one trust level provided by trust matrix 246.

Although illustrated in FIG. 2 as distinct components, signature manager 244 and trust matrix 246 may be arranged, combined, and the like, in any of a variety of ways, without departing from the scope of the present invention.

Server 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Server 200 also includes input/output interface 224 for communicating with external devices, such as a mouse, keyboard, scanner, or other input devices not shown in FIG. 2. Likewise, server 200 may further include additional mass storage facilities such as CD-ROM/DVD-ROM drive 226 and hard disk drive 228. Hard disk drive 228 is utilized by server 102 to store, among other things, application programs, databases, signature manager 244, trust matrix 246, cookie information, information received from mobile device 102 and carrier gateway 106 of FIG. 1, and the like.

Generalized Operation

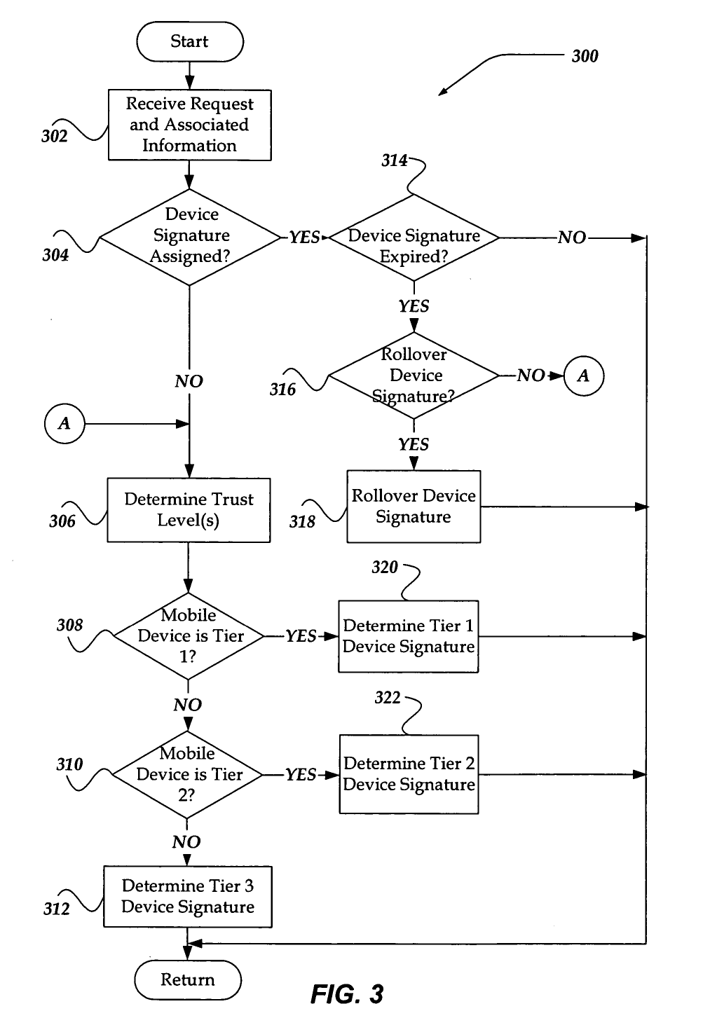

The operation of certain aspects of the present invention will now be described with respect to FIG. 3. FIG. 3 is a flow diagram generally showing one embodiment for a process of determining at least one device signature for a mobile device, in accordance with the present invention. Process 300 may be implemented within server 108 of FIG. 1.

Process 300 begins, after a start block, at block 302, where a request for information is received. The request may be from a mobile device, such as mobile device 102 of FIG. 1. Moreover, the request may be brokered through a carrier's gateway, such as carrier gateway 106 of FIG. 1. The request therefore, may include information associated with the mobile device and the carrier's gateway. If the mobile device provides a device identifier, such as a device serial number, an ESN, a MIN, and the like, the associated information may include a subscription identifier (subid). The subid may have been generated by the carrier's gateway, in part, based on the provided device identifier. In one embodiment, the associated information includes biometric, a code, a key, and the like, associated with the end-user of the mobile device. In another embodiment, the associated information indicates whether the mobile device is enabled to accept a cookie.

The associated information may further include information about the user agent (UA) executing on the mobile device. The UA information may include a program name, program type, capability identifier, and the like. The carrier's gateway may further provide information associated with the gateway, including an identifier indicating a grouping of the gateway (gatewaygrp).

Process 300 proceeds next to decision block 304, where a determination is made whether the mobile device has a device signature associated with it. If a device signature is associated with the mobile device, processing branches to decision block 314; otherwise, processing proceeds to block 306.

At block 306, at least one trust level is determined based, in part, on the associated information received at block 302. The at least one trust level may also be determined based on information that is being requested at block 302. For example, the request may be for access to secure information, private information, and the like.

In one embodiment, a tier 1 level of trust may be determined based in part, on whether a mobile device identifier is provided. A tier 2 level of trust may be determined based, in part, on whether a mobile device is enabled to accept a cookie, while a tier 3 level of trust may be determined as a default, based on whether the mobile device is enabled to interact with a URL, and the like.

At block 306, more than one trust level may be determined. For example, it may be determined that the mobile device is capable of accepting a cookie, and has provided a device identifier that may be trusted. In this situation, the mobile device may have a tier 1 and tier 2 level of trust associated with it.

At block 306, it may be determined that although the mobile device has provided a device identifier, as detected by the subid, the gatewaygrp is not sufficiently trustworthy to enable a tier 1 level of trust for communications with the mobile device. Therefore, if it is determined that the mobile device can communicate cookies, the trust levels may be set for this mobile device at tier 2, tier 3, simply tier 2, or the like. However, it may also be determined for any of a variety of reasons, that even though this mobile device can accept a cookie, a tier 3 level of trust is sufficient.

At block 306, when it is determined that the mobile device has not provided a subscription identifier, a gatewaygrp that is sufficiently trustworthy, and is unable to accept a cookie, the trust level may be set to tier 3.

However, the invention is not so limited, and any combination of tier 1, 2, and 3 may be determined, including a single tier level of trust for the mobile device. Upon determination of at least one level of trust associated with the mobile device processing proceeds to decision block 308.

At decision block 308, a determination is made whether a tier 1 level of trust is associated with the mobile device. If it is determined that a tier 1 level of trust is associated with the mobile device, processing branches to block 320; otherwise, processing proceeds to decision block 310.

At block 320, a tier 1 level of trust device signature is generated. In one embodiment, the subid, gatewaygrp, UA, and a time stamp are hashed to generate a tier 1 device signature. However, a tier 1 device signature is not limited to these arguments, and others may be employed without departing from the scope of the invention. The time stamp may be generated by a server to represent any of a number of possible events, including, but not limited to, a time when the device signature is generated, a last login time for the mobile device, and the like.

Any of a variety of hash functions may be employed to generate the tier 1 device signature, including a Message Digest 2 (MD2), MD4, MD5, Secure Hash Algorithm (SHA), Digital Encryption Standard (DES), triple-DES, Hash of Variable Length (HAVAL), RIPEMD, Tiger, and the like. Upon completion of block 320, process 300 returns to a calling process to perform other actions.

At decision block 310, a determination is made whether a tier 2 level of trust is to be associated with the mobile device. Although not required, multiple levels of trust may be associated with the mobile device. A tier 2 device signature indicates that the mobile device is enabled to accept cookies. If the tier 2 level of trust is to be associated with the mobile device processing branches to block 322; otherwise, processing proceeds to block 312.

At block 322, a tier 2 device signature is generated. In one embodiment, the tier 2 device signature is generated from a hash function employing a cookie, gatewaygrp, and UA. However, a tier 2 device signature is not limited to these arguments, and others may be employed without departing from the scope of the invention. In one embodiment a time stamp (tempo) is included in the hash. In another embodiment, the time stamp is combined with the hash function. In still another embodiment, multiple time stamps are employed, including a time stamp indicating when the cookie is first used, when the mobile device was last provided a device signature, when the mobile device last signed in, and the like.

In one scenario, a response to the mobile device's first request may include the cookie. A subsequent request from the mobile device might then include the cookie, along with the gatewaygrp, and UA information. It may be then, that the hash is performed to generate the device signature. However, the present information is not so limited and another sequence of events may be arranged. For example, associated information, from the mobile device and carrier's gateway, may be configured to include the gatewaygrp and UA in a first request for information, without departing from the scope of the present invention. In any event, upon generation of the tier 2 device signature, processing returns to a calling process to perform other actions.

At block 312, a tier 3 device signature is generated. In one embodiment, the tier 3 device signature is generated based, in part, on a hash function of the gatewaygrp, UA, a random number, a server identifier, and a process identifier. A tier 3 device signature is not limited to these arguments, and others may be employed without departing from the scope of the invention. The server identifier may be associated with the server that may service the request of the mobile device. The process identifier may be associated with a process, program, application, and the like, that is to service the request of the mobile device. The random number may include any of a variety of pseudo-random bits, truly random bits, and the like. In one embodiment, a time stamp is included in the hash. The time stamp may represent the time of creation of the hash, and the like. In another embodiment, another time stamp representing a last log in time, a last request of device signature, and the like, may be combined with the hash to generate the tier 3 device signature.

In one embodiment, the tier 3 device is sent to the mobile device employing a munged URL, and the like. As the URL, process identifier, and the like, may vary during a session with the mobile device, the tier 3 device signature may comprise a dynamic session identifier. Upon completion of block 312, processing returns to a calling process to perform other actions.

Back at decision block 314, a determination is made whether the device signature associated with the mobile device has expired. This component of an authentication check may employ a time-stamp, and the like, associated with the device signature to determine if the device signature has expired. If it is determined that the device signature has expired, processing flows to decision block 316; otherwise, processing returns to a calling process to perform other actions.

At decision block 316, a determination is made whether the device signature(s) are to be rolled over. In one embodiment, updating (rolling) the device signature(s) is based, in part, on a pre-determined period of time. For example, a tier 1 device signature may have associated with it a pre-determined period of time to expire in a range of months. A tier 2 device signature may be configured to expire in a range of hours, while a tier 3 device signature may be configured to expire in a range of minutes, and the like. The present invention is not limited to rolling over a device signature based on time, and may employ virtually any condition, event, and the like, to rollover a device signature, including, a change in a gatewaygrp, user agent employed, an activity associated with the mobile device, and the like. In any event, if it is determined that a device signature is to be rolled over, processing proceeds to block 318; otherwise, processing loops back to block 306 where at least one level of trust is determined.

At block 318, an expiration time, time-stamp and the like associate with the device signature is extended to rollover the device signature for another period of time. Upon completion of block 318, processing returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

1. A method of managing a communication with a mobile device over a network, comprising:
receiving a request from the mobile device, wherein the request includes associated information;
determining at least one level of trust based, in part, on the associated information; and
determining at least one device signature for the mobile device based on the at least one level of trust.

2. The method of claim 1, further comprising:
receiving gateway information, wherein the gateway information is associated with a carrier gateway for the mobile device; and
determining the at least one level of trust based, in part, on the associated information and the gateway information.

3. The method of claim 1, wherein the associated information comprises at least one of a device identifier, user agent information, and an indication that the mobile device is enabled to accept a cookie.

4. The method of claim 3, wherein the associated information further comprises at least one of a gateway group identifier, and a subscription identifier.

5. The method of claim 1, wherein the associated information further comprises an end-user identifier.

6. The method of claim 1, wherein the associated information further comprises a subscription identifier associated with the mobile device that is based on at least one of a Mobile Identification Number, an Electronic Serial Number, and an application serial number.

7. The method of claim 1, wherein determining the at least one level of trust further comprises:
if the associated information comprises a device identifier and trustworthy gateway information, determining a first level of trust.

8. The method of claim 1, wherein determining the at least one level of trust further comprises:
if the associated information indicates the mobile device is enabled to accept a cookie, determining a second level of trust.

9. The method of claim 1, wherein determining the at least one level of trust further comprises:
if the associated information indicates the mobile device is enabled to use a URL, determining a third level of trust.

10. The method of claim 1, wherein determining at least one device signature further comprises:
if a first level of trust is determined, determining a first tier device signature based, in part, on a hash of at least one of a subscription identifier, a gateway group identifier, a user agent identifier, and a time stamp.

11. The method of claim 1, wherein determining at least one device signature further comprises:
if a second level of trust is determined, determining a second tier device signature based, in part, on a hash of at least one of a cookie, a gateway group identifier, a user agent identifier, and a time stamp.

12. The method of claim 1, wherein determining at least one device signature further comprises:
if a third level of trust is determined, determining a third tier device signature based, in part, on a hash of at least one of a gateway group identifier, a user agent identifier, a server identifier, a process identifier, a random number, and a time stamp.

13. The method of claim 12, wherein determining the third tier device signature further comprises including the third tier device signature in a munged URL.

14. The method of claim 1, wherein determining at least one device signature further comprises employing a hash function selected from at least one of a Message Digest, a Secure Hash Algorithm (SHA), Digital Encryption Standard (DES), triple-DES, Hash of Variable Length (HAVAL), RIPEMD, and Tiger hash function.

15. The method of claim 1, further comprising expiring the at least one device signature based, in part, on a predetermined period of time associated with each of the at least one device signature.

16. The method of claim 1, further comprising:
if the at least one device signature has expired, determining if the expired device signature is to be rolled over, and
if the expired device signature is to be rolled over, extending a validity period associated with the expired device signature.

17. The method of claim 16, wherein determining if the expired device signature is to be rolled over further comprises evaluating at least one of a condition, event, change in an identifier indicating a grouping of the gateway, and a time.

18. A client adapted for a mobile device to communicate with a server over a network, the client being configured to perform actions, comprising:
sending a request to the server for content, wherein the request includes an identifier associated with a user agent;
receiving at least one device signature associated with the mobile device, wherein the at least one device signature is based on at least one level of trust.

19. The client of claim 18, wherein the client is configured to perform actions, further comprising:
providing a device identifier based on at least one of a Mobile Identification Number, an Electronic Serial Number, and an application serial number.

20. The client of claim 18, wherein receiving the at least one device signature further comprises:
if the at least one device signature is based on a first level of trust, receiving a first tier device signature based, in part, on a hash of at least one of a subscription identifier, a gateway group identifier, the user agent identifier, and a time stamp.

21. The client of claim 18, wherein receiving the at least one device signature further comprises:
if the at least one device signature is based on a second level of trust, receiving a second tier device signature based, in part, on a hash of at least one of a cookie, a gateway group identifier, the user agent identifier, and a time stamp.

22. The client of claim 18, wherein receiving the at least one device signature further comprises:
if the at least one device signature is based on a third level of trust, receiving a third tier device signature based, in part, on a hash of at least one of a gateway group identifier, a user agent identifier, a server identifier, a process identifier, a random number, and a time stamp.

23. The client of claim 18, wherein sending the request further comprises sending the request to a carrier gateway, wherein the carrier gateway is configured to perform actions, comprising:
modifying the request to include at least one of a subscription identifier associated with the mobile device, and a gateway identifier;
forwarding the modified request to the server;
receiving the at least one device signature from the server; and
forwarding the at least one device signature to the mobile device.

24. The client of claim 18, wherein receiving the at least one device signature further comprises, if the request indicates the mobile device is enabled to accept a cookie, associating the cookie with the at least one device signature.

25. The client of claim 18, wherein receiving the at least one device signature further comprises, associating a munged Uniform Resource Locator (URL) with the at least one device signature.

26. A server for managing a communication with a mobile device over a network, comprising:
a transceiver for receiving a request from the mobile device and for sending at least one device signature to the mobile device; and
a transcoder that is configured to perform actions, including:
receiving the request from the mobile device, wherein the request includes associated information;
determining at least one level of trust based, in part, on the associated information; and
determining the at least one device signature for the mobile device based on the at least one level of trust.

27. The server of claim 26, wherein the transcoder is configured to perform further action, comprising:
receiving gateway information, wherein the gateway information is associated with a carrier gateway for the mobile device; and
determining the at least one level of trust based, in part, on the associated information and the gateway information.

28. The server of claim 26, wherein determining the at least one device signature further comprises:
if a first level of trust is determined, determining a first tier device signature based, in part, on a hash of at least one of a subscription identifier, a gateway group identifier, a user agent identifier, and a time stamp.

29. The server of claim 26, wherein determining the at least one device signature further comprises:
if a second level of trust is determined, determining a second tier device signature based, in part, on a hash of at least one of a cookie, a gateway group identifier, a user agent identifier, and a time stamp.

30. The server of claim 26, wherein determining the at least one device signature further comprises:
if a third level of trust is determined, determining a third tier device signature based, in part, on a hash of at least one of a gateway group identifier, a user agent identifier, a server identifier, a process identifier, a random number, and a time stamp.

31. The server of claim 26, wherein determining the at least one level of trust further comprises determining a first level of trust based at least one of a gateway group identifier, a subscription identifier, a user agent, and a security level associated with the request from the mobile device.

32. The server of claim 26, wherein determining the at least one level of trust further comprises determining a second level of trust based at least one of a gateway identifier, a user agent, and whether the mobile device is enabled to accept a cookie.

33. The server of claim 26, wherein determining the at least one level of trust further comprises determining a third level of trust if the mobile device is enabled to interact with a URL.

34. The server of claim 26, wherein the transcoder is configured to perform further actions, comprising:
determining if at least one device signature has expired device, and
if the expired device signature is to be rolled over, extending a validity period associated with the expired device signature.

35. A system for managing a communication with a mobile device over a network comprising:
the mobile device configured to provide information associated with the mobile device; and
a server, coupled to the carrier gateway, that is configured to receive the associated information and to perform actions, including:
determining at least one level of trust based, in part, on the associated information; and
determining at least one device signature for the mobile device based on the at least one level of trust.

36. The system of claim 35, wherein determining the at least one device signature further comprises determining a tier 1 device signature based, in part, on a hash of at least one of a subscription identifier, a gateway group identifier, a user agent identifier, and a time stamp.

37. The system of claim 35, wherein determining the at least one device signature further comprises determining a tier 2 device signature based, in part, on a hash of at least one of a cookie, a gateway group identifier, a user agent identifier, and a time stamp.

38. The system of claim 35, wherein determining the at least one device signature further comprises determining a tier 3 device signature based, in part, on a hash of at least one of a gateway group identifier, a user agent identifier, a server identifier, a process identifier, a random number, and a time stamp.

39. The system of claim 38, wherein the tier 3 device signature is provided to the mobile device through a munged URL.

40. The system of claim 35, further comprising:
a carrier gateway, coupled to the mobile device, that is configured to receive the associated information, and provide the associated information and gateway information related to the carrier gateway.

41. A modulated data signal for communicating with a mobile device, the modulated data signal comprising the actions of:
receiving a request from the mobile device, wherein the request includes associated information;
sending at least one device signature to the mobile device based on the at least one level of trust that is determined, in part, using the associated information.

42. The modulated data signal of claim 41, wherein determining the at least one device signature further comprises:
if a first level of trust is determined, determining a first tier device signature based, in part, on a hash of at least one of a subscription identifier, a gateway group identifier, a user agent identifier, and a time stamp.

43. The modulated data signal of claim 41, wherein determining the at least one device signature further comprises:
if a second level of trust is determined, determining a second tier device signature based, in part, on a hash of at least one of a cookie, a gateway group identifier, a user agent identifier, and a time stamp.

44. The modulated data signal of claim 41, wherein determining the at least one device signature further comprises:
if a third level of trust is determined, determining a third tier device signature based, in part, on a hash of at least one of a gateway group identifier, a user agent identifier, a server identifier, a process identifier, a random number, and a time

45. An apparatus for communicating with a mobile device, comprising:
a means for receiving a request from a mobile device, wherein the request includes associated information;
a means for determining at least one level of trust based, in part, on the associated information; and
a means for determining at least one device signature for the mobile device based, in part, on the at least one level of trust.
